(19) United States
(12) Patent Application Publication
(10) Pub. No.: US 2009/0172011 A1
(43) Pub. Date: Jul. 2, 2009

(54) IMAGE FILE CREATION DEVICE AND IMAGE FILE CREATION METHOD

(76) Inventor: Kenichi ONOMURA, Tokyo (JP)

Correspondence Address: OSTROLENK FABER GERB & SOFFEN, 1180 AVENUE OF THE AMERICAS, NEW YORK, NY, 100368403, US

(21) Appl. No.: 12/337,045

(22) Filed: Dec. 17, 2008

(30) Foreign Application Priority Data
Dec. 26, 2007 (JP) 2007-334899

(51) Int. Cl. G06F 17/30

(52) U.S. Cl. 707/102; 707/E17.009

(57) ABSTRACT

The invention is an image file creation device for creating a first file with an extension “JPG” from an image data group composed of main image JPEG image data and a plurality of sub-image JPEG image data, the first file including the main image JPEG image data and related information from which existence of a second file related to the first file can be recognized; and creating a second file with an extension “MPF”, for example, the second file including the main image JPEG image data, the plurality of sub-image JPEG image data, and related information from which existence of the first file related to the second file can be recognized. When creating the first file and the second file, the files have the same name except for the extensions.

This application claims benefit of Japanese Application No. 2007-334899 filed in Japan on Dec. 26, 2007, the contents of which are incorporated by this reference.

### BACKGROUND OF THE INVENTION

1. Field of the Invention

The present invention relates to an image file creation device and an image file creation method capable of creating a file including a plurality of image data.

2. Description of Related Art

At the time of shooting images, one image is shot for each scene in some cases, while in other cases a plurality of images are shot by a predetermined shooting sequence such as sequential shooting, panoramic shooting, auto-bracket shooting, and multiple-viewpoint shooting (so-called stereoscopic vision image shooting). The images acquired by such a predetermined shooting sequence are highly related to one another. Therefore, it is considered to be more convenient in file operation and management to handle the images as a single file rather than to handle the images as individual files. In addition, it is considered that high convenience can be acquired not only in the case of handling the images acquired by such a shooting sequence as a single file but also, for example, in the case of handling as a single file the images acquired by fixed-point shooting in which a particular object is shot periodically and a group of images which a user thinks are highly related to one another.

Incidentally, digital still images acquired by image pickup are saved as JPG files according to the JPEG standard in many cases at present, and “JPG” is used as the extension of the files. In order to maintain file compatibility with an existing image processing device designed for handling the JPG files and a JPG application, it is required to append the extension “JPG” to the files. Furthermore, it is also required that internal structure of the files complies with the Exif standard as a de facto standard in digital cameras, and the like.

Techniques that satisfy these requirements include one disclosed in Japanese Patent Application Laid-Open Publication No. 2005-252754, for example. The technique disclosed in the publication is such that a plurality of JPEG images are put together into one file to prevent an increase in the number of files, and a main image (one main (representative) image of the plurality of images put together in a file) is stored at the head of the file in a format complying with the Exif standard, and the extension “JPG” is appended to the file itself.

Specifically, the file as shown in FIG. 12 is created. FIG. 12 is a view showing an exemplary configuration of a conventionally proposed image file in which a plurality of JPEG image data can be stored. In the image file, one JPEG image data as a main image and other n (n is an integer equal to or larger than 1) pieces of JPEG image data as sub-images other than the main image can be stored, for example. A JPEG header is added to each of the JPEG images, and one set composed of the JPEG header and the JPEG image data is configured to be sandwiched between an image start marker SOI and an image end marker EOI. In such a configuration, the image stored at the head of the image file is the main image, and in the JPEG header related to the main image are stored pointers to the sub-images which are stored in the same image file. In addition, the extension of the file name is “JPG” (the file name of the example shown in the drawing is “hogehoge.JPG”).

Such a configuration adopted in the file for storing a plurality of JPEG image data, in which the extension “JPG” and the part from the head of the file to the end of the main image has the same structure as the structure of the existing JPEG format, maintains compatibility with existing image processing devices and applications that handle JPG files. Since a plurality of image data are stored in one file, there are advantages that the number of files can be reduced and file management becomes easier.

The existing Exif standard is defined such that only one JPEG image except for a thumbnail image is stored for one JPG file. However, it is possible to allow the maker note IFD to have an image as vender unique information.

The file for storing a plurality of images, which is disclosed in the Japanese Patent Application Laid-Open Publication No. 2005-252754, can be displayed, edited and saved using an existing image processing device and application as described above, since the main image at the head of the file maintains compatibility with an existing JPG file. However, when the JPG file as disclosed in the publication is edited and saved using the existing image processing device and application complying with the above-described current Exif standard, there is a possibility that only the main image is saved but sub-images other than the main image are deleted or damaged. Therefore, a desire exists for a technology in which sub-images are not damaged even if a file is processed with an existing image processing device and application, while maintaining compatibility with the existing image processing devices and applications.

### SUMMARY OF THE INVENTION

An object of the present invention is to provide an image file creation device and an image file creation method capable of creating a file in which images are not damaged even if the file is processed with an existing device or software, while maintaining compatibility with the existing device and software.

In brief, the present invention is an image file creation device which includes; a first file creation section for creating a first file with a file name having a first extension, the first file including a first main image data created for recording based on a main image; a second file creation section for creating a second file with a file name having a second extension different from the first extension, the second file including a second main image data created for recording based on the main image and one or more sub-image data which are image data created for recording and other than the second main image data, wherein the first file creation section records in the first file related information from which the second file can be recognized as a file related to the first file, and the second file creation section records in the second file related information from which the first file can be recognized as a file related to the second file.

Furthermore, the present invention is an image file creation method which includes: creating a first file with a file name having a first extension, the first file including a first main image data created for recording based on a main image; creating a second file with a file name having a second extension different from the first extension, the second file including a second main image data created for recording based on the main image and one or more sub-image data which are image data created for recording and other than the second main image data; recording in the first file related information from which the second file can be recognized as a file related to the first file; and recording in the second file related information from which the first file can be recognized as a file related to the second file.

The above and other objects, features and advantages of the invention will become more clearly understood from the following description referring to the accompanying drawings.

### BRIEF DESCRIPTION OF THE DRAWINGS

FIG. 1 is a block diagram showing a configuration of an image file creation device according to a first embodiment of the present invention.

FIG. 2 is a view showing an exemplary configuration of image files to be recorded in a recording medium in the first embodiment.

FIG. 3 is a view showing an example of recording positions of related information in a JPEG header of the first embodiment.

FIG. 4 is a view showing a layout of image data in each of the files when an image acquired first in a shooting order is selected as a main image in the first embodiment.

FIG. 5 is a view showing a layout of the image data in each of the files when an image acquired in the middle of the shooting order is selected as a main image in the first embodiment.

FIG. 6 is a view showing an example in which main image data in a JPG file and main image data in an MPF file are not the same in the first embodiment.

FIG. 7 is a view showing another exemplary configuration of the image files to be recorded in the recording medium in the first embodiment.

FIG. 8 is a view showing a layout of the image data in each of the files corresponding to the files in FIG. 7 when an image acquired in the middle of the shooting order is selected as a main image in the first embodiment.

FIG. 9 is a flowchart showing processings from image pickup to filing when a single shooting mode or a sequential shooting mode is set in the first embodiment.

FIG. 10 is a flowchart showing processings from image pickup to filing when a panoramic shooting mode is set in the first embodiment.

FIG. 11 is a flowchart showing processings from image pickup to filing when a multiple-viewpoint shooting mode is set in the first embodiment.

FIG. 12 is a view showing an exemplary configuration of a conventionally proposed image file in which a plurality of JPEG image data can be stored.

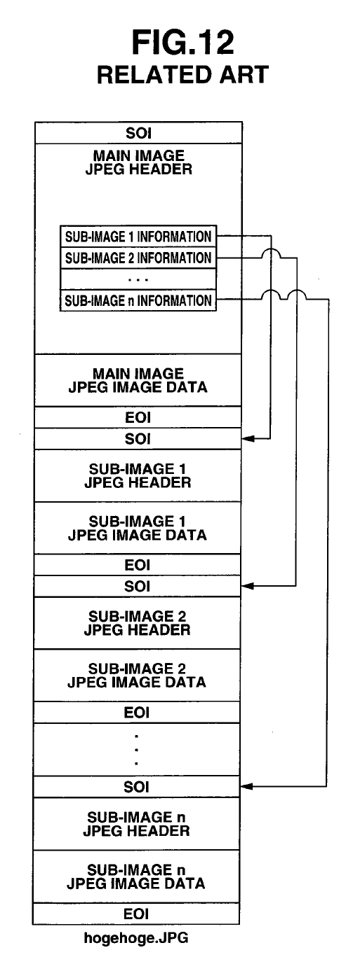

### DETAILED DESCRIPTION OF THE PREFERRED EMBODIMENT(S)

Hereinafter, embodiments of the present invention will be described with reference to the drawings.

### First Embodiment

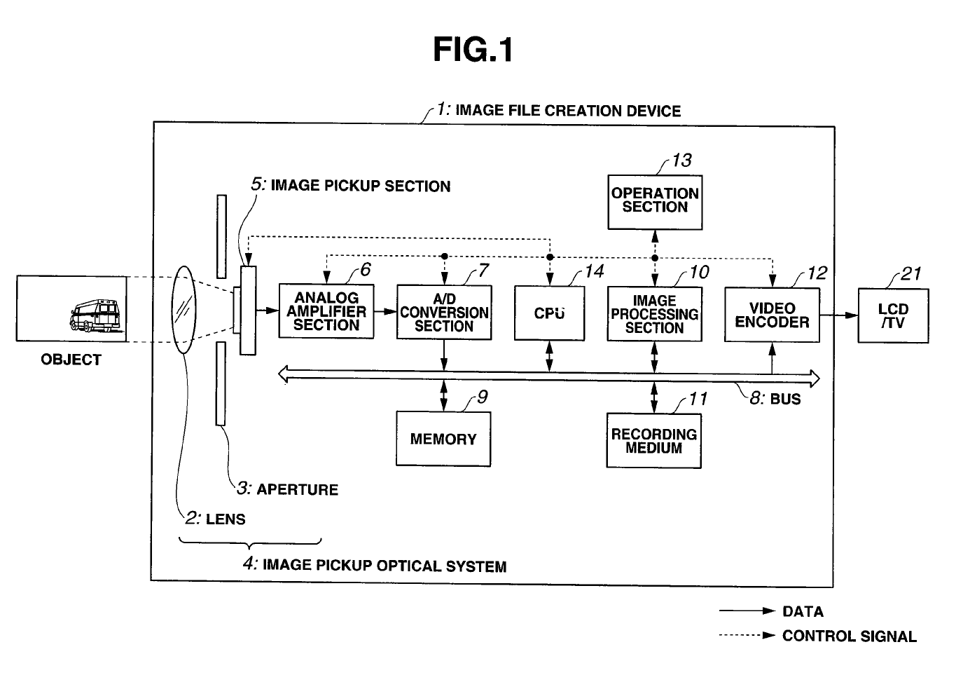

FIGS. 1 to 11 show the first embodiment of the present invention. FIG. 1 is a block diagram showing a configuration of an image file creation device.

The image file creation device 1 is equipped with an image pickup function, and configured as a digital camera, for example.

That is, the image file creation device 1 includes: an image pickup optical system 4 including a lens 2 and an aperture 3; an image pickup section 5; an analog amplifier section 6; an A/D conversion section 7; a bus 8; a memory 9; an image processing section 10; a recording medium 11; a video encoder 12; an operation section 13; and a CPU 14.

The lens 2 is to form an optical image of an object in the image pickup section 5.

The aperture 3 is to adjust the brightness of the optical image to be formed by defining a passing range of the light flux reaching from the lens 2 to the image pickup section 5.

The image pickup section 5 photoelectrically converts the formed optical image to generate an analog electric image signal and outputs the generated image signal.

The analog amplifier section 6 amplifies the analog image signal outputted from the image pickup section 5.

The AID conversion section 7 converts the analog image signal amplified by the analog amplifier section 6 into a digital image.

The digital image converted by the A/D conversion section 7 is stored in the memory 9 via the bus 8. The bus 8 is used when each of the sections transmits and receives data, and connected with the A/D conversion section 7, the memory 9, the image processing section 10, the recording medium 11, the video encoder 12, and the CPU 14.

The memory 9 is configured as a storage section capable of relatively high-speed access, such as DRAM, for example. The memory 9 is used not only as a buffer for storing the image from the A/D conversion section 7, the image processed by the image processing section 10, the image read from the recording medium 11, and the like, but also as a working area for the CPU 14.

The image processing section 10 performs image processing on the digital image stored in the memory 9 to generate image data for recording (the present embodiment assumes JPEG data), and writes the data back in the memory 9 again. In addition, the image processing section 10 generates also image data for display, as needed, and stores the generated image data in the memory 9.

To the image data for recording generated by the image processing section 10 are added a header and the like by the CPU 14, and thereby an image file is generated.

The recording medium 11 records the generated image file in a nonvolatile manner based on a control by the CPU 14, and is configured of a flash memory and the like, for example.

The video encoder 12 reads out the image data for display stored in the memory 9 to convert the image data into a video signal and the like, and outputs the signal and the like to the outside. The video encoder 12 is connected with a liquid crystal display device or a television device (LCD/TV) 21 as an external device, for example, to display an image.

The operation section 13 is for a user to input various operations to the image file creation device 1. The possible operations by the operation section 13 include for example: an on/off operation of a power supply; a release operation for instructing to start image shooting; a mode selection operation for selecting operation modes such as a sequential shooting mode, a panoramic shooting mode, a multiple-viewpoint shooting mode and an auto-bracket shooting mode; and a main image selection operation for selecting a main image from among a plurality of picked-up images.

The CPU 14 is a control section for integrally controlling the sections in the image file creation device 1, and serves also as a first file creation section, a second file creation section and a main image selection section. Furthermore, as described above, the CPU 14 performs processing for generating an image file by creating a header and adding the header to the image data for recording, and a control for recording the generated image file in the recording medium 11. In addition, the CPU 14 also performs processing for selecting a main image from among a plurality of images by automatic processing or a manual operation.

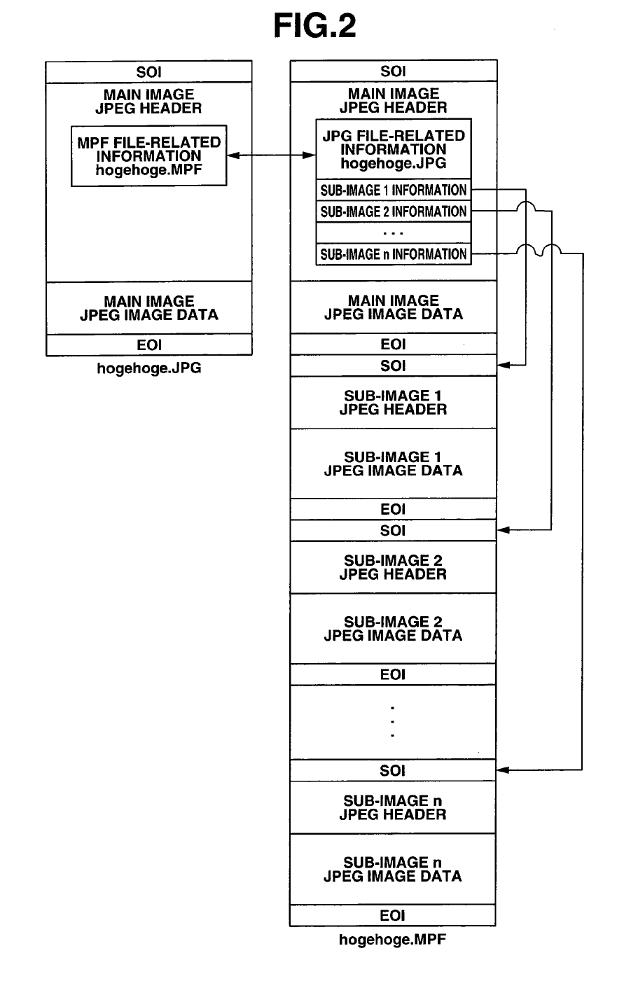

Next, FIG. 2 is a view showing an exemplary configuration of image files to be recorded in a recording medium in the first embodiment.

FIG. 2 is a view to describe how to file and record a series of image groups shot based on a predetermined shooting sequence (several examples are shown above, which are sequential shooting sequence, panoramic shooting sequence, multiple-viewpoint shooting sequence, auto-bracket shooting sequence, and the like).

First, one of the correlated image data is selected as main image data. The methods of selecting the main image data include a method in which the selection is manually performed by a user through the operation section 13 and a method in which the selection is automatically performed based on judgment by the CPU 14 serving also as the main image selection section. The method of automatically selecting the main image includes, for example, a method of selecting the image shot first as a main image when a plurality of images are acquired by a sequential shooting sequence. Furthermore, the method includes a method of selecting an image shot in the middle of the shooting order among a plurality of images as a main image when the images are acquired by a panoramic shooting sequence, for example. Thus, one example of the method of automatically selecting the main image includes automatically selecting an image in a specific place in the shooting order. The specific place may be changed according to shooting modes. In addition, other unselected images in the image groups are automatically treated as sub-images.

In the present embodiment, as shown in FIG. 2, two files are created for the image group. One file is a JPG file having a file name extension “JPG”(the file name is “hogehoge.JPG” in the example shown in the drawing). The other file is an MPF file having a file name extension “MPF”(which means multi-picture format), for example (the file name is “hogehoge.MPF” in the example shown in the drawing). Thus, the file names of the JPG file and the MPF file are determined such that the file name parts except for the extensions are the same.

The JPG file of these files is a file having a complete compatibility with existing JPG files. In the part sandwiched between the image start marker SOI placed at the head of the file and the image end marker EOI placed at the end of the file is placed only one main image JPEG image data (except for thumbnail image) as image data, and the main image JPEG header is recorded at the head side of the main image JPEG image data. In the main image JPEG header, MPF file-related information showing that an MPF file related to this JPG file exists is recorded in a format complying with the Exif standard. The MPF file-related information includes also the file name of the MPF file (“hogehoge.MPF” in the example shown in the drawing).

In addition, the MPF file has a configuration as shown on the right side of FIG. 2. That is, in the MPF file are stored one main image JPEG image data and n (n is an integer equal to or larger than 1) pieces of sub-image JPEG image data with the JPEG headers attached to the image data, respectively. The sets each composed of the JPEG header and the JPEG image data are aligned respectively sandwiched between the image start marker SOI and the image end marker EOI. In the example shown in FIG. 2, the main image is placed at the head of the MPF file. (However, the configuration is not limited to this, which will be described later.)

Among these headers, in the header of the main image JPEG image data which is the image data placed at the head of the MPF file, that is, the main image JPEG header, JPG file-related information showing that an JPG file related to this MPF file exists is recorded in a format complying with the Exif standard. The JPG file-related information includes also the file name of the JPG file (the file name “hogehoge.JPG” in the example shown in the drawing).

Furthermore, in the main image JPEG header placed at the head of the MPF file, pointers to the sub-image data (in more detail, the image start markers SOI related to the respective sub-image data) included in the MPF file are stored, for example, as offset addresses and the like.

Note that the main image JPEG image data in the JPG file and the main image JPEG image data in the MPF file do not necessarily have to be completely the same data (a specific example in which these are different data will be described later), as long as these data are created for recording based on the same main image acquired by image pickup.

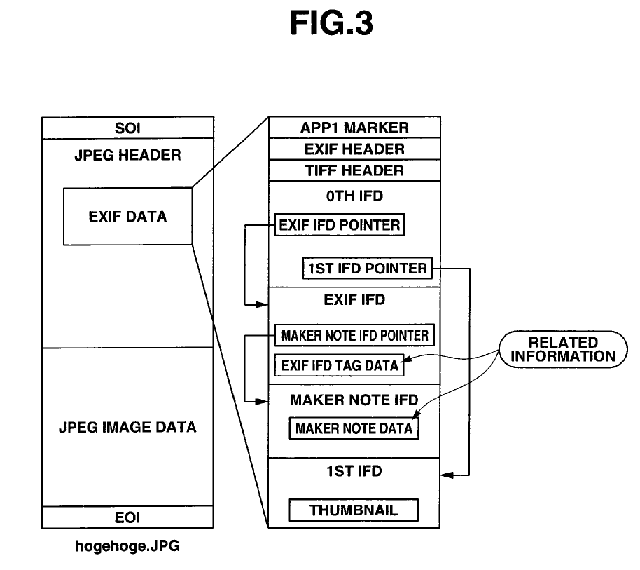

FIG. 3 is a view showing an example of recording positions of related information in the JPEG header. Though FIG. 3 shows an example of the header of JPG file, the header of the MPF file also has the same configuration.

The JPEG header complies with the Exif standard and includes Exif data. As shown on the right side of FIG. 3 in an enlarged manner, the Exif data includes an Appl marker, an Exif header, a TIFF header, a 0th IFD, an Exif IFD, a maker note IFD, and a 1st IFD (However, in FIG. 3, for simplification, only the main IFDs are shown).

The 0th IFD includes pointers to the Exif IFD and to the 1st IFD.

The Exif IFD includes a pointer to the maker note IFD and Exif IFD tag data.

In addition, the maker note IFD includes maker note data.

The 1st IFD includes thumbnail image data.

In such a configuration, the positions in which related information is recorded include, for example, a position in the Exif tag data or a position in the maker note data. The recording of the related information in the maker note data is described completely complying with the existing Exif standard, since data description in the maker note is freely defined in the existing Exif standard. On the other hand, the recording of the related information in the Exif IFD tag data needs slightly expanding the existing Exif standard to add a new tag, since the tag of the Exif IFD has already been defined in the existing Exif standard. However, since the Exif standard is a standard which should be appropriately expanded and version-upgraded, in the future version-upgraded Exif standard, it is much anticipated that the related information will be able to be recorded without expanding the standard. Accordingly, both the case completely complying with the existing Exif standard and the case complying with the Exif standard by slightly expanding the existing Exif standard are assumed to be called broadly as “complying with the Exif standard”.

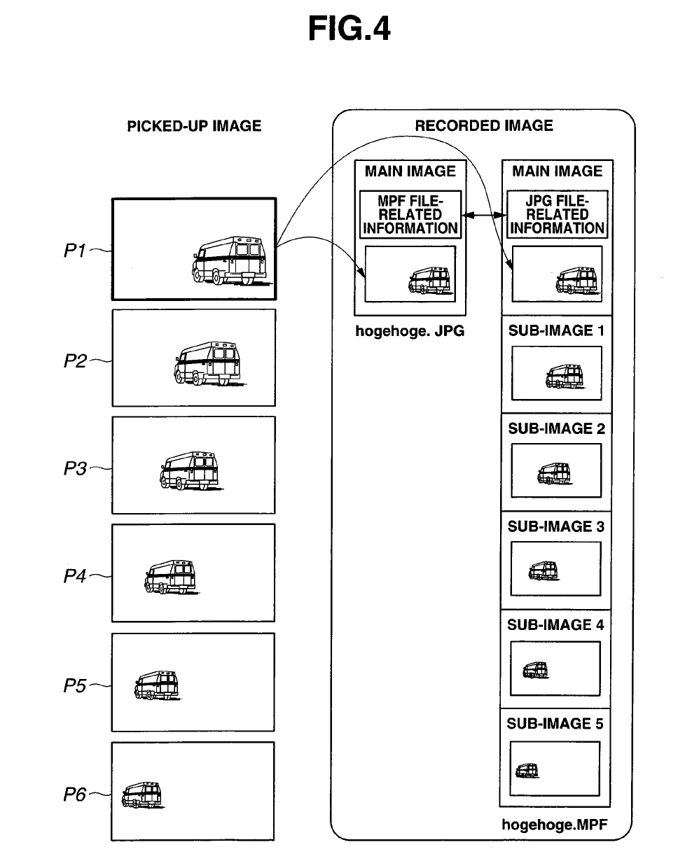

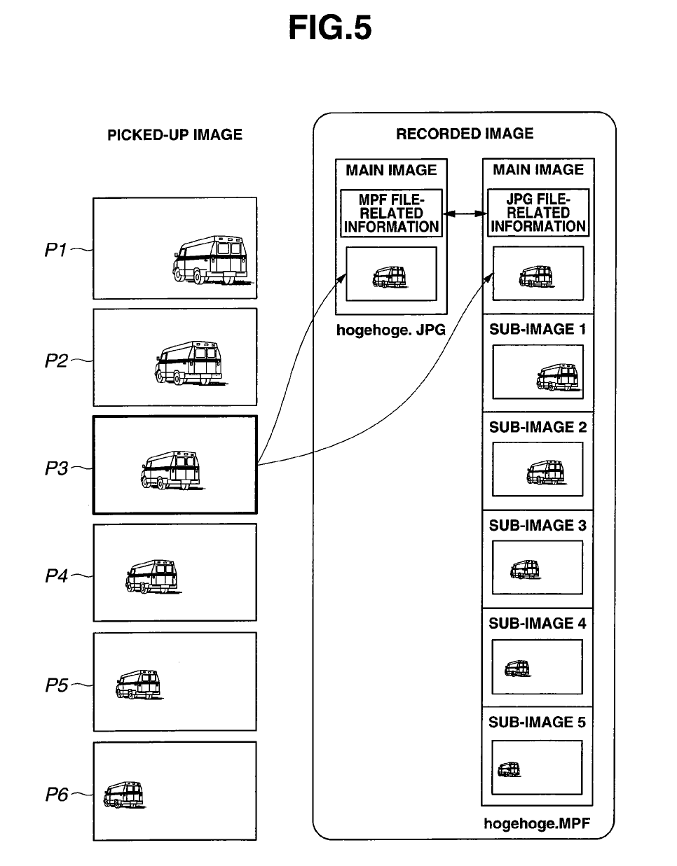

Next, description will be made on the position of the main image in the shooting order and the layout of each of the image data in the MPF file, with reference to FIGS. 4 and 5. FIG. 4 is a view showing the layout of image data in each of the files when an image acquired first in the shooting order is selected as a main image. FIG. 5 is a view showing the layout of the image data in each of the files when an image acquired in the middle of the shooting order is selected as a main image.

First, a predetermined shooting sequence is assumed to be a sequential shooting sequence, and six images P1 to P6 are assumed to be acquired in this order. Then, among these six images, the first image in the shooting order is assumed to be automatically or manually selected as a main image.

At this time, at the head of the MPF file, the main image data created for recording based on the main image is placed, and thereafter according to the shooting order, data from sub-image data 1 corresponding to the image P2 to sub-image data 5 corresponding to the image P6 are placed.

On the other hand, as shown in FIG. 5, when the third image in the shooting order among the six images P1 to P6 is automatically or manually selected as a main image, the main image data created for recording based on the third image P3 as the main image is placed at the head of the MPF file, and thereafter according to the shooting order, the sub-image data 1 corresponding to the image P1, the sub-image data 2 corresponding to the image P2, the sub-image data 3 corresponding to the image P4, the sub-image data 4 corresponding to the image P5, and the sub-image data 5 corresponding to the image P6 are placed. Therefore, in the example shown in FIG. 5, since it is prioritized to place the main image at the head of the MPF file, the layout order of the image data in the MPF file is not generally the same as the shooting order of the images.

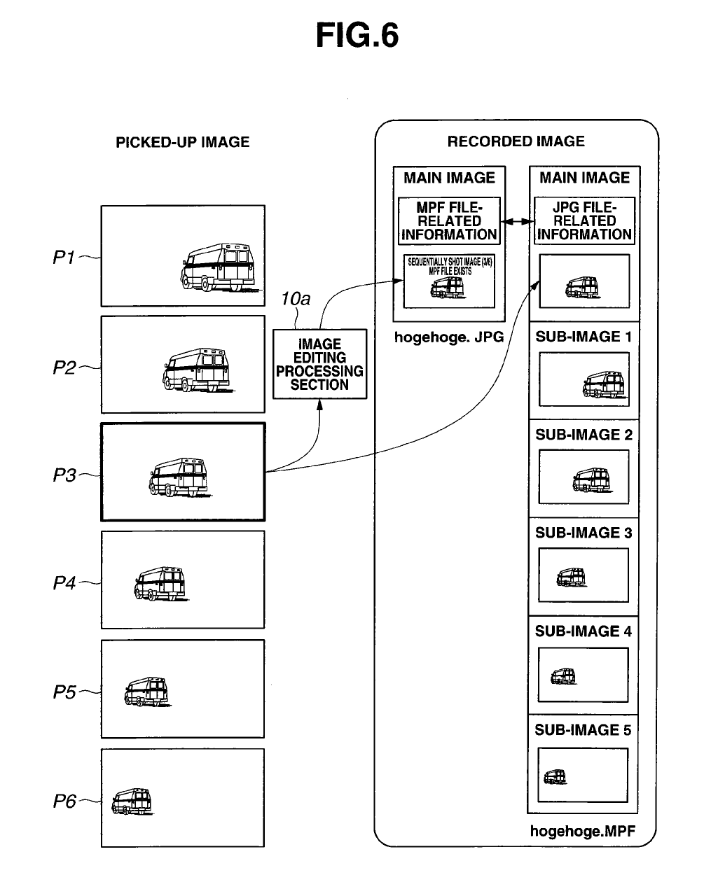

FIG. 6 is a view showing an example in which the main image data in the JPG file and the main image data in the MPF file are not the same.

As described above, there is not necessarily a need for the image data created for recording based on the main image to be the same in the JPG file and in the MPF file. In the example shown in FIG. 6, the main image data to be stored in the MPF file is the data acquired by JPEG-compressing the main image as-is. In contrast, the main image data to be stored in the JPG file is the image data subjected to image editing.

That is, same as in the example shown in FIG. 5, it is assumed that the main image is the thirdly shot image P3. The image P3 is subjected to a processing by an image editing processing section 10a provided in the image processing section 10. The processing is to embed, as visually recognizable image information, the information indicating that the selected main image is the third image among the six images acquired by sequential shooting (in the example shown in the drawing, “sequentially shot image (3/6)) and the information indicating that the MPF file corresponding to the JPG file exists (in the example shown in the drawing, “the MPF file exists”). Then, the image data subjected to the image editing processing is recorded as the main image of the JPG file. According to such a configuration, a mere sight of the JPG file enables the user to recognize at a glance the existence of other images related to the image which is displayed at present.

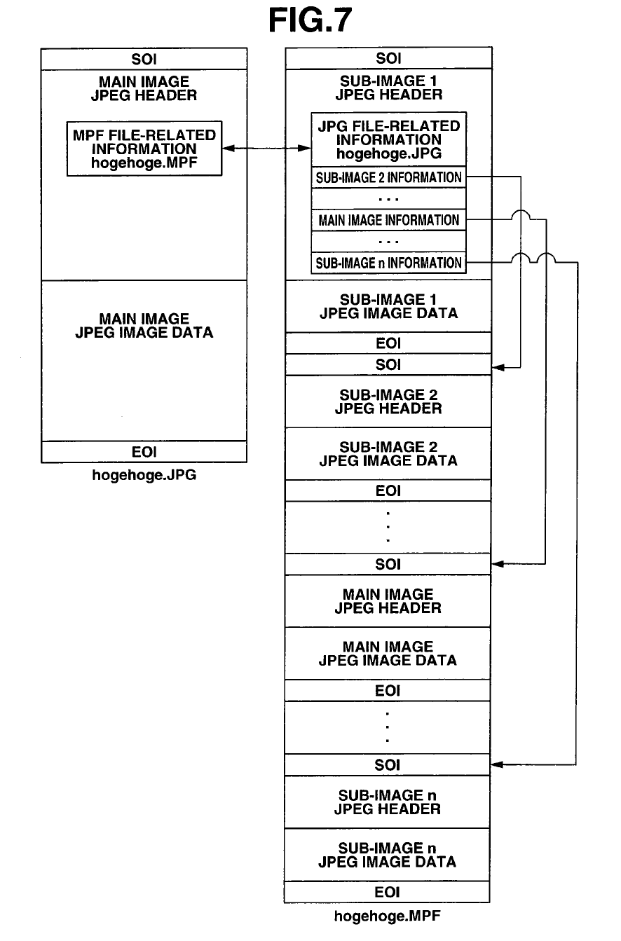

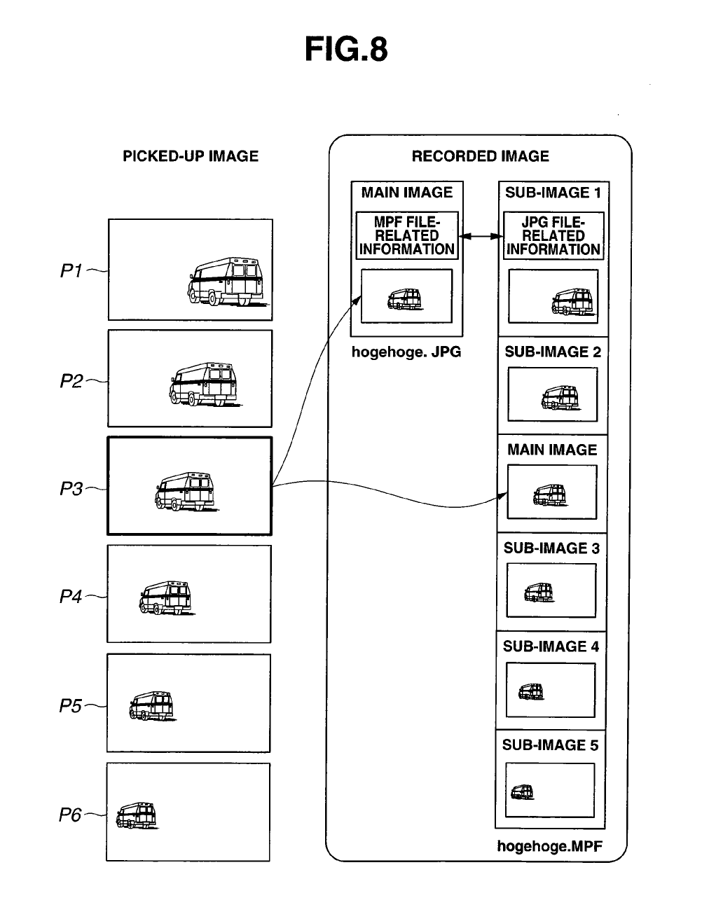

In addition, in the examples shown in FIGS. 2 to 6, the main image data is placed at the head of the MPF file. However, examples different from this configuration will be described with reference to FIGS. 7 and 8. FIG. 7 is a view showing another exemplary configuration of the image files to be recorded in the recording medium. FIG. 8 is a view showing the layout of the image data in each of the files corresponding to the files in FIG. 7 when the image acquired in the middle of the shooting order is selected as a main image.

In the example shown in FIG. 7, the main image is not necessarily placed at the head of the MPF file (needless to say, there is a possibility that the main image is placed at the head of the file), and is placed in an appropriate position according to a predetermined order. Here, a representative example of “the predetermined order” is the order that the images were shot. In such a configuration, every time images are sequentially shot, the image data have only to be added sequentially from the head of the file, which eliminates the need for the memory 9 to have a capacity for storing as many pieces of image data as assumed to be sequentially shot. Therefore, there is an advantage that cost can be reduced.

Same as in the example shown in FIG. 5, FIG. 8 shows the layout of the image data in the exemplary configuration of the image files shown in FIG. 7, in a case where the third image in the shooting order among the six images P1 to P6 is automatically or manually selected as the main image.

In this case, the image data to be placed at the head of the MPF file is the sub-image data 1 corresponding to the first image P1 in the shooting order, and the image data to be placed next is the sub-image data 2 corresponding to the second image P2 in the shooting order. Then, the image data to be placed next is the main image data corresponding to the third image P3 in the shooting order. Thereafter, the image data from the sub-image data 3 corresponding to the fourth image P4 in the shooting order to the sub-image data 5 corresponding to the sixth image P6 in the shooting order are sequentially placed. Therefore, in the example shown in FIG. 8, since it is prioritized to place the image data in the shooting order in the MPF file, the main image data is not necessarily placed at the head of the MPF file.

In such a configuration of the MPF file, the JPG file-related information and the pointers to the sub-image data 2, the main image data, the sub-image data 3, the sub-image data 4, and the sub-image data 5 are stored in the JPEG header of the sub-image data 1 which is placed at the head of the file. That is, both in the above-described examples shown in FIG. 5 and FIG. 8, the related information and pointers to the respective image data are stored in the JPEG header which is placed at the head of the MPF file, regardless of whether the header is related to the main image or to the sub-image.

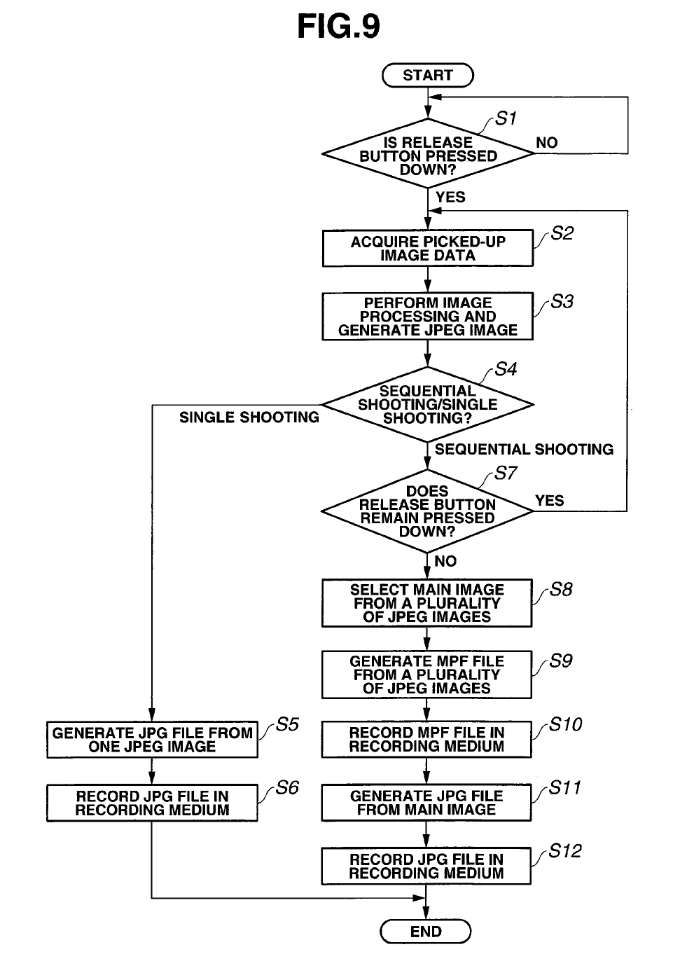

Next, FIG. 9 is a flowchart showing processings from image pickup to filing when a single shooting mode or a sequential shooting mode is set.

When the single shooting mode or the sequential shooting mode is set by the operation section 13, the processings are started.

First, determination is made on whether or not a release button included in the operation section 13 is pressed down (step S1). Here, it is waited until the release button is pressed down.

When it is determined that the release button has been pressed down, image data is acquired from the image pickup section 5 through the analog amplifier section 6 and the A/D conversion section 7, and the acquired image data is stored in the memory 9 (step S2).

Then, based on the control by the CPU 14, the image processing section 10 reads the picked-up image and performs a predetermined image processing thereon, and thereafter performs JPEG compression to generate the JPEG image data and store the generated JPEG image data in the memory 9 again (step S3).

Subsequently, determination is made as to whether the shooting mode is the single shooting mode or the sequential shooting mode (step S4).

When it is determined that the shooting mode is the single shooting mode, the CPU 14 adds the JPEG header to one generated JPEG image data to generate a JPG file (step S5) and records the generated JPG file in the recording medium 11 (step S6), to terminate the processing.

On the other hand, when it is determined that the shooting mode is the sequential shooting mode in step S4, determination is made on whether or not the release button remains pressed down (step S7).

When it is determined that the release button remains pressed down, the processing returns to the step S2, and next image is picked up and processes the picked-up image into JPEG image data as described above.

Furthermore, if it is determined that the release button is not pressed down in the step S7, which means the end of the sequential shooting, then the main image data is selected from among a plurality of acquired JPEG image data (step S8). As described above, the selection of the main image data may be manually performed by the user seeing the image data displayed on the LCD/TV 21. Alternatively, the CPU 14 may automatically select as a main image an image in a predetermined place in the shooting order of the images.

Next, a JPEG header is added to each of the plurality of JPEG image data acquired by sequential shooting, and related information and information on the pointers to the respective image data are added especially to the JPEG header placed at the head of the file to generate an MPF file (step S9). The generated MPF file is stored in the recording medium 11 (step S10).

Subsequently, the JPEG header including the related information is added to the selected main image JPEG image data to generate a JPG file (step S11). The generated JPG file is recorded in the recording medium 11 (step S12), to terminate the processing.

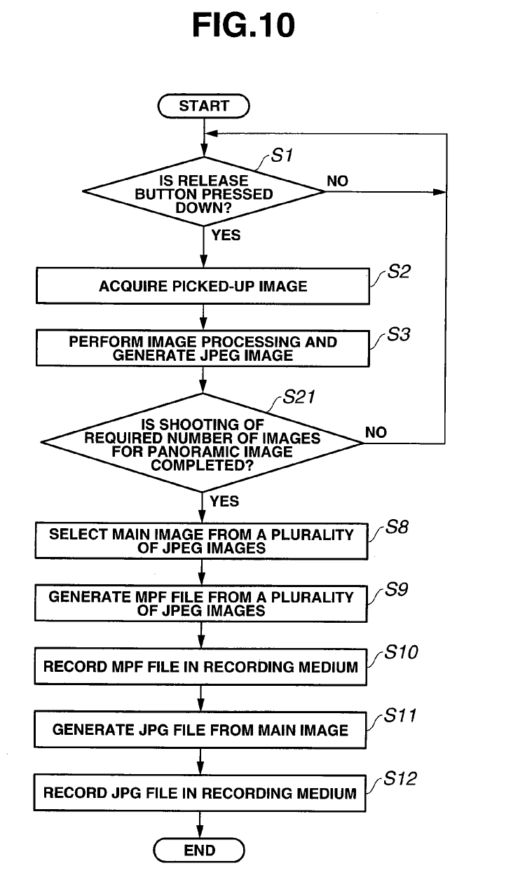

Next, FIG. 10 is a flowchart showing processings from image pickup to filing when a panoramic shooting mode is set. The panoramic shooting mode is, as is well known, a shooting mode to shoot a plurality of images with a camera set at basically the same position while shifting (panning, for example) the shooting direction (shooting optical axis) of the camera such that the successively shot images have portions overlapping one another (strictly speaking, the images do not have to have overlapping portions if no blank portion exists), and to generate one image with wide field angle by combining the images after the completion of shooting.

The flow of the processings in the panoramic shooting mode is basically the same as the above-described processings in FIG. 9. The only difference is that the processings from the steps S4 to S6 are omitted, and after the processing in step S3 is performed, instead of the processing in step S7, determination is made whether or not the shooting of required number of images for generating a panoramic image is completed (step S21), and when the shooting is not completed, the processing returns to the step S1 to perform next shooting. When the shooting is completed, the processings in step S8 to S12 are performed similarly as the processings in FIG. 9.

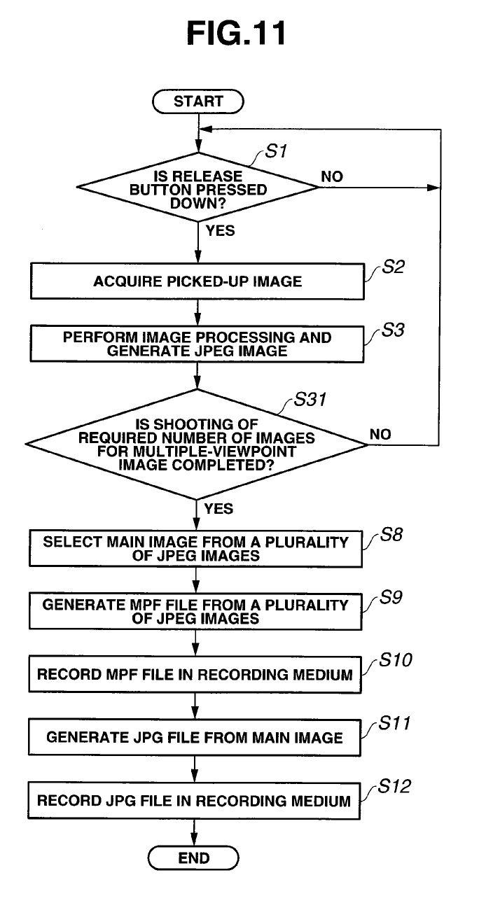

Next, FIG. 11 is a flowchart showing processings from image pickup to filing when a multiple-viewpoint shooting mode is set. The multiple-viewpoint shooting mode is to shoot a plurality of images by changing the position where the camera is set with a specific object set at the center (such that the shooting optical axis is directed to the specific object). Taking some examples, when two-viewpoint shooting is performed, a stereoscopic image similar to an image binocularly observed by a human being can be generated. When a specific object is shot from multiple viewpoints from a whole circumferential direction, a stereoscopic image in which the specific object can be observed from any direction can be generated.

The flow of processings in the multiple-viewpoint shooting mode is basically the same as the above-described processings in FIG. 10. The only difference is that determination is made whether or not the shooting of the required number of multiple-viewpoint images is completed (step S31) instead of the processing in the step S21.

Note that, as the examples of acquiring an image group including a plurality of images, the sequential shooting mode, the panoramic shooting mode and the multiple-viewpoint shooting mode are described above. However, the shooting mode is not limited to these modes, and may be an auto-bracket shooting mode or other shooting mode. Furthermore, the case where one JPEG image data is created for recording corresponding to one image acquired by image pickup, that is, the case where the picked-up image and the recorded image correspond one to one with each other is taken as an example here, but no limitation is placed thereon. For example, a plurality of JPEG images each having different color balance are generated based on one picked-up image, and a JPG file and an MPF file may be generated by selecting one image among from these JPEG images and treating other images as sub-images.

In addition, the image group is not limited to one configured of a series of images shot in a specific shooting mode. The image group may be selected among from the images shot and accumulated by the user, for example, and the JPF file and the MPF file may be generated from the image group.

In addition, the JPEG image data is given above as the example of image data generated for recording. However, there is no limitation placed thereon. Therefore, the image file compatible with a conventional image processing device (or image processing program and the like) is not limited to the JPG file. Furthermore, it is needless to say that the extension of the image file in which a plurality of image data are put together is also not limited to “MPF”.

Furthermore, as an example of automatically selecting the main image from the image group, the case where the image in a specific place (for example, first, middle, last and the like) in the shooting order is selected is given above. However, there is no limitation placed thereon. For example, though more advanced technology is required, an image analysis may be performed on each of the images included in the image group to analyze the characteristics of each of the images, and the image which is determined to be the most suitable as the main image based on the analysis result may be automatically selected as the main image. At present, it is difficult to perform such an analysis on an arbitrary object in every shooting scene. However, it is possible even with a current technology to analyze a specific shooting scene such as of a sequentially shot racing car in a circuit, for example, and automatically select a main image. Therefore, it is preferable to provide an automatic main image selection mode for each shooting scene assuming several shooting scenes.

According to the first embodiment thus configured, since one image file (JPG file in the specific example) compatible with conventional image processing devices and the like is created and recorded for the image group, compatibility can be secured.

In addition, the main image data and the sub-image data are put together into one file (MPF file in the specific example), which is created and recorded separately from the image file having compatibility. Therefore, only two files in total are generated for the image group, which enables easy file management.

In addition, the extension of the second image file in which a plurality of image data are put together is differentiated from the extension of the compatible first image file. Therefore, even when image processings (processings such as image editing and storing) are performed by an image processing device and the like which cannot handle the second image file, the second file is not processed, which reduces the risk that the second image file is deleted.

The compatible image file, in particular, is created as a JPG file which is considered to be the most prevalent at present, which can maintain compatibility with a wide range of image processing devices and the like.

Since the image data is to be stored in the second image file as JPEG image data, the image data can be generated using a JPEG encoder, which is considered to be the most prevalent, and the decoding and extraction of the image data become easy, thereby increasing versatility.

In addition, the JPG file and the MPF file have the same file name part except for the extensions. Therefore, even when only the JPG file is edited by an image processing device and the like which do not support MPF files and the related information in the JPG file is deleted, for example, it is possible to locate the MPF file related to the JPG file based on the file name part except for the extension. Furthermore, many devices handle a group of files having the same file name except for the extensions as one object. Therefore, versatility of the files can be increased when the files are handled with such devices.

In addition, when the main image data file is placed at the head of the second image file, it is possible to preferentially access the main image data as a representative image data among the plurality of image data.

On the other hand, in a case where the image data is sequentially stored in the shooting order in the second image file, the file can be created by connecting image data at the end of the file for each shooting. Therefore, there is no need for ensuring a buffer with a capacity for storing many pieces of image data, which allows simple configuration and reduced cost.

In addition, in the JPG file, the related information is recorded in the JPEG header. Therefore, unlike the case where another file is provided to record the related information, there is no increase in the number of files, and unlike the case where a new recording portion other than the JPEG header is provided to record the related information, there is no deterioration in compatibility. As a result, the related information can be easily read out.

On the other hand, in the MPF file, the related information is recorded in the JPEG header placed at the head of the file among the JPEG headers provided respectively for the JPEG image data. Therefore, the MPF file similarly has such advantages as high versatility, preferential accessibility, and easy operation.

The JPEG header is brought into compliant with the Exif standard and set in a de facto standard format, thereby enabling the compatibility with existing devices and the like to be maintained.

In addition, in either one of the image files to be generated which have two kinds of extensions, the file name of the other one of the image files is contained. Therefore, it is possible to retrieve and access the other one of the image files by using the file system configured in the recording medium.

The images acquired by sequential shooting by a predetermined shooting sequence without sandwiching other image between the images are considered to be the images highly related to one another. Therefore, it is considered that the images deserve to be integrated into one as the MPF file.

Since, in particular, the sequentially shot images are the images sequentially acquired at short shooting time intervals, the images are highly related to one another. In addition, it is expected that the number of shot images is increased if a recent high-speed reading type image pickup device which can reduce the shooting time intervals is used. Therefore, it is considered that image groups acquired by such a sequential shooting highly deserve to be put together into one as the MPF file.

A panoramic image can only have a meaning when a plurality of images are combined, and the images are highly related to one another. Therefore, it is more valuable to put the image together into one as the MPF file than to store each of the images in separate files.

Furthermore, in the multiple-viewpoint shooting, one object is shot from different viewpoints, and the images are highly related to one another. Therefore, it is more valuable to put the images together into one as the MPF file than to store each of the images in separate files.

In addition, in the automatic selection of main image data, by selecting an image in a specific place in the shooting order, it is possible to easily select the main image without a need of manual operation. By changing the specific place in the shooting order depending on the shooting mode at this time, it is possible to select more appropriate main image in accordance with the shooting mode.

On the other hand, in the manual selection of main image data, there is an advantage that the most appropriate image data which meets the user's requirements as the main image. For example, when the user would like to select the image in which the target object is in the best position as a main image in the group of images acquired by sequential shooting, the image in which the target object in the best position is not always (not usually) the image in the specific place of the shooting order. Therefore, in such a case, it is effective that the user manually select the main image.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An image file creation device comprising:
a first file creation section for creating a first file with a file name having a first extension, the first file including a first main image data created for recording based on a main image;
a second file creation section for creating a second file with a file name having a second extension different from the first extension, the second file including a second main image data created for recording based on the main image and one or more sub-image data which are image data created for recording and other than the second main image data,
wherein the first file creation section records in the first file related information from which the second file can be recognized as a file related to the first file, and the second file creation section records in the second file related information from which the first file can be recognized as a file related to the second file.

2. The image file creation device according to claim 1, wherein the first main image data is JPEG data, the first extension is “JPG”, and the second extension is an extension different from the “JPG”.

3. The image file creation device according to claim 2, wherein the second main image data and the sub-image data are JPEG data.

4. The image file creation device according to claim 1, wherein the file name of the first file and the file name of the second file are the same except for the extensions.

5. The image file creation device according to claim 1, wherein the second file creation section creates the second file such that the second main image data is placed at a head of the file and the one or more sub-image data are placed following the second main image data.

6. The image file creation device according to claim 2, wherein the first file creation section creates the first file such that the first file includes a JPEG header corresponding to the first main image data, and records the related information in the JPEG header.

7. The image file creation device according to claim 6, wherein the JPEG header complies with an Exif standard.

8. The image file creation device according to claim 3, wherein the second file creation section creates the second file such that the second file includes a JPEG header corresponding to the second main image data and one or more JPEG headers corresponding to the one or more sub-image data, and records the related information in the JPEG header corresponding to the image data placed at the head of the second file, of the second main image data and the one or more sub-image data.

9. The image file creation device according to claim 8, wherein the JPEG header corresponding to the second main image data and the one or more JPEG headers corresponding to the one or more sub-image data comply with an Exif standard.

10. The image file creation device according to claim 1, wherein
the first file creation section causes the second file name to be included in the related information from which the second file can be recognized as a file related to the first file, and
the second file creation section causes the first file name to be included in the related information from which the first file can be recognized as a file related to the second file.

11. The image file creation device according to claim 1, wherein
the one or more sub-image data are image data created for recording based on one or more sub-images other than the main image, and
the main image and the one or more sub-images are images acquired by sequential shooting without placing other image between the images by a predetermined shooting sequence.

12. The image file creation device according to claim 11, wherein the predetermined shooting sequence is a sequential shooting sequence.

13. The image file creation device according to claim 11, wherein the predetermined shooting sequence is a panoramic shooting sequence.

14. The image file creation device according to claim 11, wherein the predetermined shooting sequence is a multiple-viewpoint shooting.

15. The image file creation device according to claim 1, wherein
the one or more sub-image data are image data created for recording based on one or more sub-images other than the main image, and
the image file creation device further comprises a main image selection section which selects the main image from among a plurality of images acquired by shooting and treats other unselected images as the sub-images, and which automatically selects an image in a specific place in a shooting order as the main image.

16. The image file creation device according to claim 1, wherein
the one or more sub-image data is image data created for recording based on one or more sub-images other than the main image, and
the image file creation device further comprises an operation section for performing an operation to select the main image from among a plurality of images and treat other unselected images as the sub-images.

17. The image file creation device according to claim 1, further comprising an image editing processing section for creating the first main image data by adding image information visually showing that the second file related to the first file exists, when the first image data is created for recording based on the main image.

18. An image file creation method comprising:
creating a first file with a file name having a first extension, the first file including a first main image data created for recording based on a main image;
creating a second file with a file name having a second extension different from the first extension, the second file including a second main image data created for recording based on the main image and one or more sub-image data which are image data created for recording and other than the second main image data;
recording in the first file related information from which the second file can be recognized as a file related to the first file; and
recording in the second file related information from which the first file can be recognized as a file related to the second file.
